(19) United States
(12) Patent Application Publication
(10) Pub. No.: US 2025/0138866 A1
(43) Pub. Date: May 1, 2025

(54) QUEUE CALCULATION SYSTEM, QUEUE CALCULATION APPARATUS, QUEUE CALCULATION METHOD, AND PROGRAM

(71) Applicant: NIPPON TELEGRAPH AND TELEPHONE CORPORATION, Tokyo (JP)

(72) Inventor: Atsunori ICHIKAWA, Tokyo (JP)

(21) Appl. No.: 18/692,055

(22) PCT Filed: Oct. 15, 2021
(86) PCT No.: PCT/JP2021/038295

§ 371 Date: Mar. 14, 2024

(51) Int. Cl. G06F 9/48; G06F 16/23

(52) U.S. Cl. CPC G06F 9/4818; G06F 16/2365

(57) ABSTRACT

Provided is a queue computation system that executes processing on an oblivious priority queue, the queue computation system including: a storage unit that stores a data structure in which layered randomized arrays and a binary tree are combined; and a calculation unit that performs an operation on the data structure. In the data structure, each piece of data is stored in a randomized array of any layer together with a priority, and each node in the binary tree is capable of retaining, as element information, data, priority, position, and layer information in the randomized arrays.

### TECHNICAL FIELD

The present invention relates to a technology for achieving a data structure in which data is concealed from a server such as a cloud when the data is stored on the server.

### BACKGROUND ART

In the following description, reference literature names with literature numbers are shown at the end of the specification, and when a reference literature is referred to in the specification, the literature number is described as “[1]” or the like.

A priority queue is a data structure in which each piece of data is stored with information regarding “priority” added thereto, and when the data is extracted, the pieces of data are extracted in ascending (or descending) order of “priority”.

The priority queue is a technology that can be utilized in various ways, such as being able to be used not only for graph problems such as implementation of sort (heap sort) and shortest path problems but also for storage of stream data, sequential sort/sampling, and the like, and being compatible with sensing data using IoT.

There is a technology called an oblivious priority queue [3, 4, 8, 10, and 11] as a method of using such a priority queue while entrusting storage of data to an unreliable external server or the like. This allows for a queue operation with the order of operations on the data, the priority of each piece of data, and the like concealed from the server, by not only storing the data concealed by encryption or the like in the server but also randomizing an algorithm for data reference.

### CITATION LIST

### Non Patent Literature

Non Patent Literature 1: Tomas Toft. Secure data structures based on multi-party computation. In PODC, pages 291-292, 2011.

### SUMMARY OF INVENTION

### Technical Problem

Non Patent Literature 1 (Reference Literature [10]) described above discloses a method achieved for the first time for a conventional oblivious priority queue. Although the technology disclosed in Non Patent Literature 1 is a highly secure method that prevents stochastic corruption of the data structure, there has been a problem in that only data insertion and highest-priority data deletion, which are minimum operations, are possible, and “the operation being performed (insertion or deletion)” is leaked to the server.

On the other hand, all the follow-on technologies ([3, 4, 8, and 11]) that have achieved addition of a function (arbitrary data deletion or priority change) or concealment of operation contents have a problem in that the data structure is stochastically corrupted.

The present invention has been made in view of the above points, and it is an object of the present invention to provide a technology that allows an advanced operation to be performed on an oblivious priority queue while preventing stochastic corruption of a data structure.

### Solution to Problem

The disclosed technology provides a queue computation system that executes processing on an oblivious priority queue, the queue computation system including:
a storage unit that stores a data structure in which layered randomized arrays and a binary tree are combined; and
a calculation unit that performs an operation on the data structure,
wherein, in the data structure, each piece of data is stored in a randomized array of any layer together with a priority, and each node in the binary tree is capable of retaining, as element information, data, priority, position, and layer information in the randomized arrays.

### Advantageous Effects of Invention

According to the disclosed technology, it is possible to perform an advanced operation on an oblivious priority queue while preventing stochastic corruption of a data structure.

### BRIEF DESCRIPTION OF DRAWINGS

FIG. 1 is a diagram illustrating an example of a device configuration in an embodiment of the present invention.

FIG. 2 is a diagram illustrating an example of a network configuration according to the embodiment of the present invention.

FIG. 3 is a diagram illustrating a data structure for achieving an oblivious priority queue.

FIG. 4 is a diagram illustrating a processing procedure of Example 2.

FIG. 5 is a diagram illustrating an outline of Example 2.

FIG. 6 is a diagram illustrating a processing procedure of Example 3.

FIG. 7 is a diagram illustrating a processing procedure of Example 4.

FIG. 8 is a diagram illustrating a processing procedure of Example 6.

FIG. 9 is a diagram illustrating a processing procedure of Example 7.

FIG. 10 is a diagram illustrating a processing procedure of Example 8.

FIG. 11 is a diagram illustrating a hardware configuration example of an apparatus.

### DESCRIPTION OF EMBODIMENTS

Hereinafter, an embodiment of the present invention (the present embodiment) will be described with reference to the drawings. The embodiment described below is merely an example, and embodiments to which the present invention is applied are not limited to the following embodiment.

### Outline of Embodiment

The present embodiment describes a technology for achieving an oblivious priority queue, in which the technology simultaneously satisfies the following three: (1) a data structure that prevents stochastic corruption, (2) addition of arbitrary data deletion or priority change function, and (3) concealment of operation contents, the three not having been achieved by conventional arts.

In the technology according to the present embodiment, for example, a case can be assumed in which data owned by a client is entrusted to a server. Here, the number of clients may be one or more, and the number of servers may be one or more. In a case where the number of servers is two or more, processing on the client side can be reduced by a multi-party computation technology (for example, [12]). In addition, by using multi-party computation, it is possible to construct an oblivious priority queue between a plurality of servers even in a case where there is no client.

### System Configuration Example

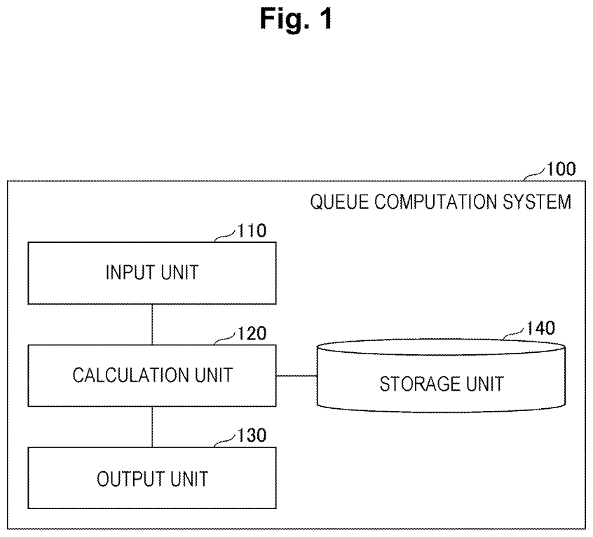

FIG. 1 illustrates a functional configuration example of a queue computation system 100 according to the present embodiment. As illustrated in FIG. 1, the queue computation system 100 includes an input unit 110, a calculation unit 120, an output unit 130, and a storage unit 140. The queue computation system may be referred to as a “queue computation apparatus”.

The input unit 110 inputs data necessary for processing. The storage unit 140 stores data having a data structure described in Example 1. The calculation unit 120 executes operations described in Examples 2 to 8 on the data stored in the storage unit 140. The output unit 130 outputs a calculation result.

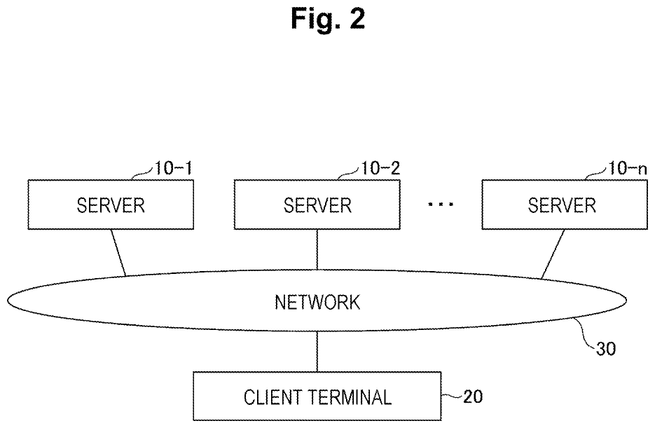

The queue computation system 100 may be one server (computer) having a function of executing an algorithm based on secure computation, may be a system constituted by a plurality of servers, or may be a system constituted by a client terminal and one or more servers as illustrated in FIG. 2.

In a case where the queue computation system 100 is constituted by a plurality of servers, the “calculation unit 120+storage unit 140” corresponds to a computation function and a storage function implemented by the plurality of servers. Furthermore, in a case where the queue computation system 100 is constituted by a client terminal and one or more servers, the “calculation unit 120+storage unit 140” corresponds to a computation function and a storage function implemented by the client terminal and the one or more servers.

### Prior Art Used in Present Embodiment

In the present embodiment, some pieces of prior art are used in processing operations of the queue computation system 100. Outlines of these pieces of prior art will be described below.

### <Data Concealment and Recovery>

Concealment of a plaintext x is represented by [[x]]. The concealment may be performed by using common key cryptography or public key cryptography (e.g., Reference Literature [9]), by using a secret sharing scheme (e.g., Reference Literature [7]) in a case where there is a plurality of servers, or by using any other method that satisfies equivalent functions and security.

### <Array Shuffling>

Processing of shuffling a concealed array [[A]]=([[a₁], . . . , [[aₘ]]) while keeping the order of arrangement of elements secret is described as follows:

[[π]],[[A′]]←Shuffle([[A]])

Then, the inverse operation of the shuffling is described as follows:

[[A]]←Unshuffle([[π]],[[A′]])

Here, π is information indicating substitution of an array, and A′=πA is satisfied.

As a method for achieving the above, for example, a protocol [6] executed between a client and a server or a protocol [5] cooperatively executed by a plurality of servers can be used.

### <Comparison (Multi-Party Computation)>

Comparison calculation in multi-party computation is described as follows:

[[c]]←E_{Q}([[a]],[[b]]),[[d]]←L_{T}([[a]],[[b]])

Here, c is 1 if a=b holds, and c is 0 if a=b does not hold. Furthermore, d is 1 if a<b holds, and d is 0 if a<b does not hold.

As a method for achieving the above, for example, the method described in Reference Literature [1] can be used.

### <Conditional Selection (Multi-Party Computation)>

Conditional selection in multi-party computation is described as follows.

[[c]]←IfElse([[f]],[[a]],[[b]])

Here, when f∈{0, 1} holds, c=a holds if f=1 holds, and c=b holds if f=1 does not hold.

As a method for achieving the above, for example, the method described in Reference Literature [4] can be used.

### <Oblivious One-Time Memory>

An oblivious one-time memory (OTM) is a data structure described in Reference Literature [2], and has a property that stochastic corruption does not occur. The OTM is constituted by the following three algorithms: Build, Lookup, and Getall. The OTM may be referred to as a randomized array. However, the randomized array is not limited to the OTM.
OTM.Build([[A]]): An algorithm to construct a data structure OTM. When the number of elements of the input array [[A]] is m, the constructed OTM has, as components, an array [[T]] having 2m elements and an array [[Pos]] having m elements. At this time, the elements of the input [[A]] are stored somewhere in the array [[T]], and the remaining elements of [[T]] are filled with dummy data. Where in [[T]] the elements of [[A]] exist is recorded in [[Pos]].
OTM.Lookup([[pos]]): An algorithm to reference the data structure OTM. The input pos is either one of the elements of the above [[Pos]] or dummy information, and the algorithm Lookup either (1) references a pos-th element of the array [[T]] if pos is real (one of the elements of [[Pos]]), or (2) references any piece of dummy data in [[T]] if pos is a dummy. At this time, data that has been referenced once is deleted from the OTM (more precisely, overwritten with dummy data).
OTM.Getall( ): An algorithm to deconstruct the data structure OTM. An array having m elements is output, the array including all pieces of actual data remaining in the OTM (the elements of the original array [[A]]).

Here, while the OTM has the arrays [[T]] and [[Pos]] as components, it is assumed that the OTM may have any other components.

While the storage location of [[T]] for storing a data body in the OTM is not limited to a specific location, the present embodiment is based on the assumption that, as an example, the data body is stored on the server side. The other elements may be stored in either the server or the client terminal.

While the above algorithm is implemented by cooperative computation between a client and a server in Reference Literature [2], it is possible to implement equivalent functions with only a plurality of servers without a client by simply replacing shuffling, which is a component thereof, and comparison and selection of values on the client side with shuffling, comparison, and conditional selection by multi-party computation.

Hereinafter, specific processing details executed by the queue computation system 100 will be described using Examples 1 to 8. In the following description, a “data structure” may be used to mean data having that structure. Examples 1 to 8 can be executed in any combination. The queue computation system 100 may include all the functions of Examples 1 to 8 or may include only some of the functions of Examples 1 to 8.

### Example 1

In the present example, a data structure for achieving a new oblivious priority queue will be described. Data of this data structure is stored in the storage unit 140 of the queue computation system 100.

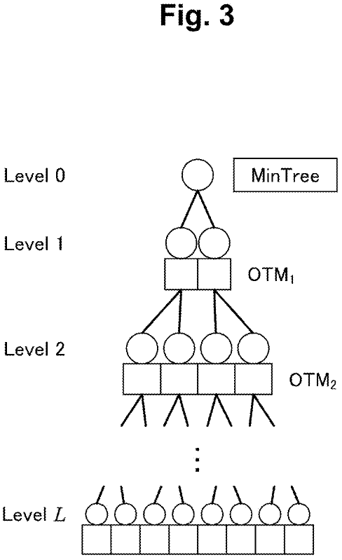

This data structure is illustrated in FIG. 3. As illustrated in FIG. 3, this data structure has a structure in which OTMs existing in a layered manner and a binary tree data structure are combined. As for the OTMs, as illustrated in Reference Literature [2], OTMs are retained in which a Level_1 layer has one piece of actual data and one piece of dummy data, and similarly, a Level_i layer has 2ⁱ⁻¹ pieces of actual data and 2ⁱ⁻¹ pieces of dummy data. In addition, in the present example, a node of a binary tree graph is given so as to correspond to each element of a data array [[T]], which is a component of the OTMs, and a root of the binary tree is given as Level_0.

In this data structure, each piece of data d and priority p are combined into ([[p]], [[d]]) as a lump and stored in the OTM of any of the levels, and the OTM of each level gets into either a “filled (retaining a specified number of pieces of data)” state or an “empty (having no data)” state.

It is assumed that each node of the binary tree can retain only one set ([[p]], [[d]], [[pos]], [[lv]]). Note that pos, lv is information indicating that “data ([[p]], [[d]]) is the pos-th element of the OTM of Level_lv”. Among the four items included in ([[p]], [[d]], [[pos]], [[lv]]), [[d]] is not necessarily retained.

### Example 2

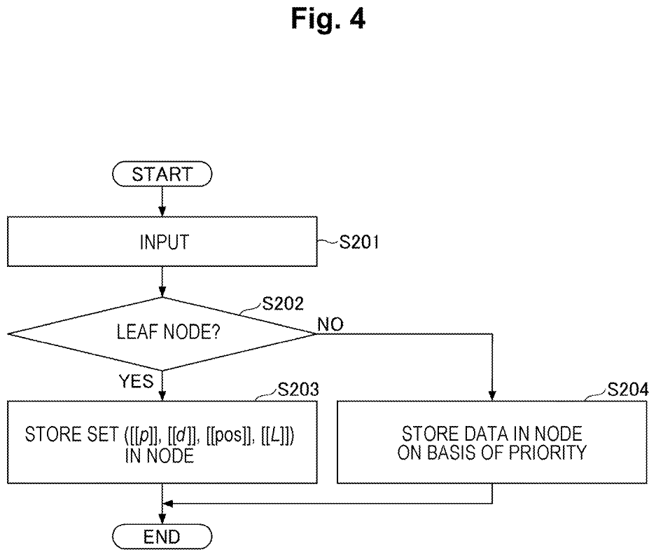

The present example describes an operation for updating a node of the binary tree in the data structure described in Example 1. FIG. 4 is a flowchart illustrating a procedure of an operation executed by the queue computation system 100.

In S201, an arbitrary node of the binary tree in the data structure of Example 1 is input from the input unit 110. In S202, the calculation unit 120 determines whether the input node is a leaf node (corresponding to Level_L in FIG. 3). If the input node is a leaf node, the processing proceeds to S203, and if the input node is not a leaf node, the processing proceeds to S204.

In S203 (if the input node is a leaf node), the calculation unit 120 stores, in that node, a set ([[p]], [[d]], [[pos]], [[L]]) obtained by combining an element ([[p]], [[d]]) of an OTM corresponding to that node, the position pos, and the layer L.

In S204 (if the input node is not a leaf node), the calculation unit 120 selects data with the lowest priority among data ([[pₗ]], [[dₗ]], [[posₗ]], [[lvₗ]]) and data ([[pᵣ]], [[dᵣ]], [[posᵣ]], [[lvᵣ]]) respectively retained by nodeₗ and nodeᵣ that are a left child and a right child of that node, and the element ([[p]], [[d]]) of the OTM corresponding to that node, and then stores the selected data in that node. However, in a case where ([[p]], [[d]]) has the lowest priority, ([[p]], [[d]]) is stored with position information pos, lv of the data added as in S203 described above.

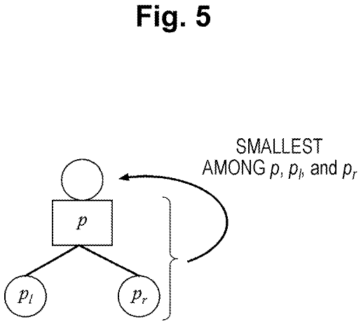

FIG. 5 illustrates an image of the processing of S204 described above. As illustrated in FIG. 5, data retained by the target node, the left child node, or the right child node, whichever is smallest in priority value, is stored in the target node. In the present example, the smaller the value of the priority of the data, the higher the priority of the data.

For implementation of the operation in Example 2, for example, in a case of a client-server model, the client terminal can perform the operation by acquiring necessary data (the element of the OTM corresponding to the node, and the child nodes of the node) from the server, decoding the acquired data into a plaintext, and performing magnitude comparison, or in a case where there is a plurality of servers, the servers themselves can perform the operation by using magnitude comparison and conditional selection of multi-party computation.

### Example 3

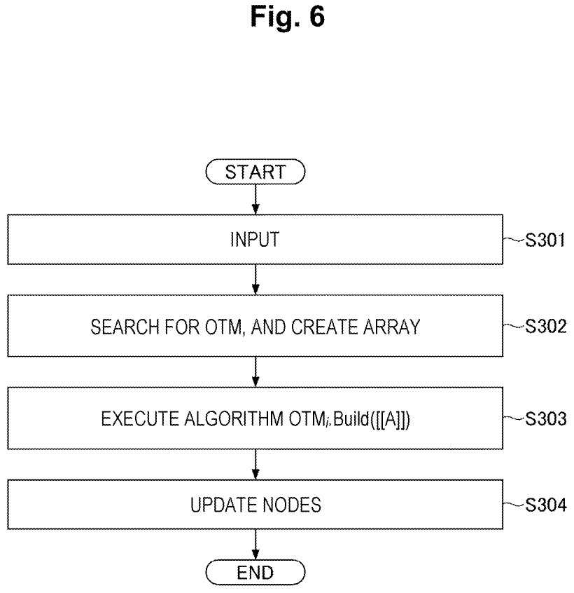

In the present example, the queue computation system 100 executes processing for reproducing an “insertion” operation for a priority queue by using the data structure of Example 1, the algorithm of Example 2, and operation algorithms of the OTMs. FIG. 6 is a flowchart illustrating a procedure of an insertion operation executed by the queue computation system 100.

In S301, ([[p]], [[d]]), which is a pair of data d to be newly inserted and the priority p thereof, is input from the input unit 110.

In S302, the calculation unit 120 searches through data (the data structure of Example 1) stored in the storage unit 140 in order from Level_1 for an “empty” OTM that is closest to the uppermost layer. Here, assuming that an OTMᵢ, which is the OTM of Level_i, is the first empty OTM, data is first extracted by an algorithm OTMⱼ.Getall( ) for all OTMs before Level_i (0<j<i), and all data strings are combined to form a large array (the number of elements is 2ⁱ⁻¹−1). Every OTMⱼ from which the data has been extracted returns to the “empty” state.

In S303, the calculation unit 120 attaches the data (and the priority thereof) to be newly inserted to the end of the array created in S302 to obtain an array [[A]] having 2ⁱ⁻¹ elements. Using this, the calculation unit 120 executes an algorithm OTMᵢ.Build([[A]]) so that the OTMᵢ gets into a “filled” state.

In S304, the calculation unit 120 uses the method of Example 2 to update, in order from Level_i where the data has been newly stored to Level_0, all nodes belonging to the same Level.

In the present example, an “empty” layer into which new data (data to be inserted) is to be inserted is specified in S302, all pieces of data in the upper layers, together with the new data, are moved and stored in the “empty” layer in S303, and finally, in S304, the relationships between the OTMs and the binary tree in which correspondence relationships have changed with the movement of the data are renewed, and thus the insertion operation for a priority queue is reproduced.

As long as the update operation of Example 2 is maintained, each node of the binary tree always retains “data with the lowest priority among the children of the node”, and this allows “data with the lowest priority in the data structure” to be retained in the root node.

In a similar manner to the component algorithms, all the operations of the present example can be executed both by the client-server model and by multi-party computation between servers.

### Example 4

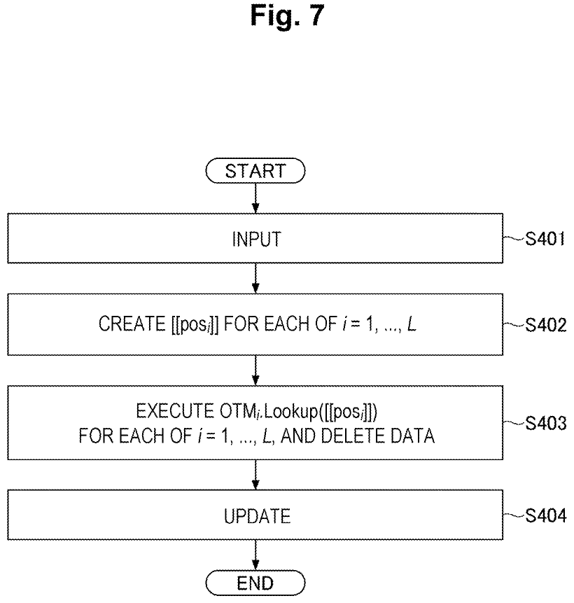

In the present example, the queue computation system 100 executes processing for reproducing a “delete” operation for a priority queue by using the data structure of Example 1, the algorithm of Example 2, and the operation algorithms of the OTMs. FIG. 7 is a flowchart illustrating a procedure of a delete operation executed by the queue computation system 100.

In S401, the input unit 110 inputs ([[pos]], [[lv]]) indicating the position of data to be deleted.

In S402, the calculation unit 120 creates [[posᵢ]] for each of i=1, . . . , L such that (i) posᵢ=pos holds if i=lv holds, and (ii) posᵢ=⊥ holds if i=lv does not hold. Here, ⊥ is a value representing a dummy.

In S403, the calculation unit 120 executes OTMᵢ.Lookup([[posᵢ]]) for each of i=1, . . . , L, and deletes target data (or dummy data) in each layer. At this time, the target data can be referenced and stored as necessary. In this case, it is determined whether the target data in each layer is a dummy, and only real data that is not a dummy is selected and stored.

In S404, the calculation unit 120 uses the method of Example 2 to update, in order from a lower layer, all nodes corresponding to the positions where the reference (deletion) has occurred in each layer in S403 described above and all parent nodes of the nodes.

In the present example, in order to delete specific data from the data structure (while concealing which data the data is), reference (or deletion) is uniformly executed across all the layers. At that time, in order to prevent unnecessary data deletion, dummy reference is performed on a layer (i≠lv) that does not retain target data. Thereafter, for all the positions where reference has occurred (whether dummy or non-dummy), there is a possibility that the priority relationship has changed, and thus the nodes are updated, all the way back to the root node.

In a similar manner to the component algorithms, all the operations of the present example can be executed both by the client-server model and by multi-party computation between servers.

### Example 5

In the present example, the queue computation system 100 executes processing for performing a “highest-priority data reference” operation for a priority queue on the data structure of Example 1. The highest-priority data reference does not particularly require input, and can be performed simply by “returning data stored in the node of Level_0” in the present example. In a case where each node of the binary tree does not retain [[d]], the “highest-priority data reference” operation can be performed by (1) extracting the highest-priority data by the method described in Example 6, and (2) reinserting the same data by the method described in Example 3.

In a similar manner to the component algorithms, all the operations of the present example can be executed both by the client-server model and by multi-party computation between servers.

### Example 6

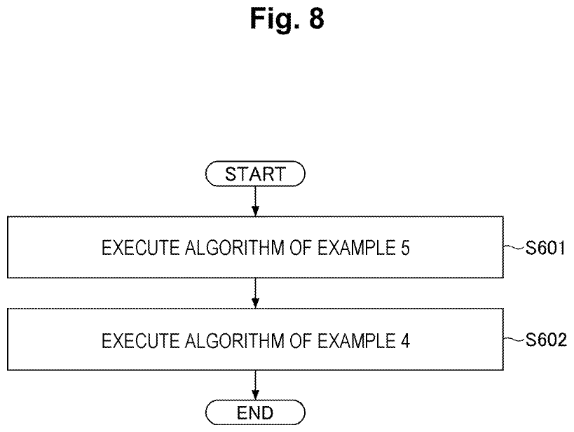

In the present example, the queue computation system 100 executes processing for performing a “highest-priority data extraction” operation for a priority queue by using the data structure of Example 1 and the algorithms of Examples 4 and 5. FIG. 8 is a flowchart illustrating a procedure of a “highest-priority data extraction” operation executed by the queue computation system 100. The highest-priority data extraction does not particularly require input.

In S601, the calculation unit 120 acquires position information [[pos]], [[lv]] of the highest-priority data by the algorithm of Example 5.

In S601, the calculation unit 120 references the data at the position [[pos]], [[lv]] by the algorithm of Example 4, acquires the highest-priority data ([[p]], [[d]]), and deletes the highest-priority data from the data structure.

In a similar manner to the component algorithms, all the operations of the present example can be executed both by the client-server model and by multi-party computation between servers.

### Example 7

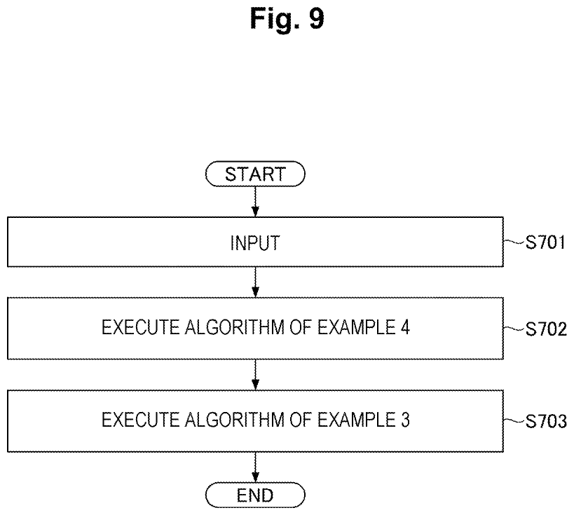

In the present example, the queue computation system 100 executes processing for performing a “priority change” operation for a priority queue by using the data structure of Example 1 and the algorithms of Examples 3 and 4. FIG. 9 is a flowchart illustrating a procedure of the “priority change” operation executed by the queue computation system 100.

In S701, the position [[pos]], [[lv]] of change target data, priority [[p′]] after the change, and data [[d]] are input from the input unit 110.

In S702, the calculation unit 120 deletes the data at the position [[pos]], [[lv]] by the algorithm of Example 4.

In S703, the calculation unit 120 inserts ([[p′]], [[d]]) by the algorithm of Example 3.

The operation of the present example is an operation of changing the priority of specific data (p, d) stored in a priority queue to (p′, d), and is performed, in the present example, by deleting the data and then changing the priority and reinserting the data.

In a similar manner to the component algorithms, all the operations of the present example can be executed both by the client-server model and by multi-party computation between servers.

### Example 8

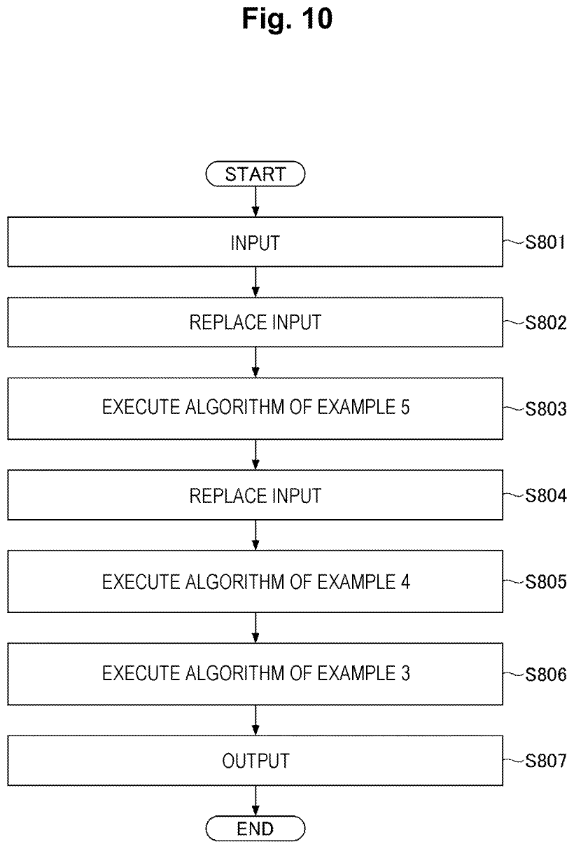

In the present example, the queue computation system 100 executes processing in which all the algorithms of Examples 2 to 7 are integrated, and all operations can be performed with “operation contents” performed on a priority queue also concealed from the server. FIG. 10 is a flowchart illustrating an operation procedure of Example 8 executed by the queue computation system 100.

In S801, in addition to the arbitrary data position [[pos]], [[lv]] and the priority and data [[p]], [[d]], information [[op]];op∈{insert,delete,find_min,extract_min,update_priority} that expresses the operation content is input from the input unit 110.

In S802, the calculation unit 120 replaces the input as follows in accordance with the value of op.

(i) If op=insert holds, [[pos]], [[lv]] is replaced with a dummy.

(ii) If op=delete holds, [[p]], [[d]] is replaced with a dummy.

(iii) If op=find_min or op=extract_min holds, [[p]], [[d]], [[pos]], [[lv]] is replaced with a dummy. (Note that this operation may not be performed in a case where an appropriate input is guaranteed from the beginning.)

In S803, the calculation unit 120 acquires data ([[pₘᵢₙ]], [[dₘᵢₙ]]) with the lowest priority and the position [[posₘᵢₙ]], [[lvₘᵢₙ]] thereof by the algorithm of Example 5. In a case where each node of the binary tree does not retain [[d]], only acquisition of the position [[posₘᵢₙ]], [[lvₘᵢₙ]] is performed by the algorithm of Example 5 (reference/deletion and reinsertion are not performed).

In S804, the calculation unit 120 replaces the input as follows in accordance with the value of op. That is, if op=extract_min holds, [[pos]], [[lv]] is replaced with [[posₘᵢₙ]], [[lvₘᵢₙ]]. In a case where each node of the binary tree does not retain [[d]], if op=find_min or extract_min holds, [[pos]], [[lv]] is replaced with [[posₘᵢₙ]], [[lvₘᵢₙ]].

In S805, the calculation unit 120 references and deletes the data at the position [[pos]], [[lv]] by the algorithm of Example 4. The data referenced at this time is referred to as ([[p′]], [[d′]]).

In S806, the calculation unit 120 inserts ([[p]], [[d]]) by the algorithm of Example 3. In a case where each node of the binary tree does not retain [[d]], if op=find_min holds, [[p]], [[d]] is replaced with [[p′]], [[d′]].

In S807, if op=find_min or op=extract_min holds, the calculation unit 120 outputs ([[pₘᵢₙ]], [[dₘᵢₙ]]) from the output unit 130, and if “op=find_min or op=extract_min” does not hold, a dummy is output. In a case where each node of the binary tree does not retain [[d]], if op=find_min or extract_min holds, ([[p′]], [[d′]]) is output from the output unit 130.

The algorithm of Example 8 is constituted by a combination of Examples 5, 4, and 3, and it is possible to simulate all operations by controlling an input to these algorithms with the use of a dummy. The relationships between the operation contents and the examples are as follows: insert: Example 3, delete: Example 4, find_min: Example 5, extract_min: Example 6, and update_priority: Example 7.

In the present example, conditional branching of replacing an input can be easily achieved by controlling the input value on the client side in the case of a client-server model, and can be achieved by combining a plurality of comparisons and conditional selections in the case of multi-party computation between servers, and thus, all can be executed in combination with another algorithm both by the client-server model and by the multi-party computation between servers.

### Hardware Configuration Example

The queue computation system 100 can be implemented by, for example, causing one or more computers to execute a program. The one or more computers may be physical computers, or may be virtual machines on a cloud.

That is, the queue computation system 100 can be implemented by executing a program corresponding to processing performed by the queue computation system 100 using hardware resources such as a CPU and a memory built in each of the one or more computers. The above program can be stored and distributed by being recorded in a computer-readable recording medium (a portable memory or the like). The above program can also be provided through a network such as the Internet or an electronic mail.

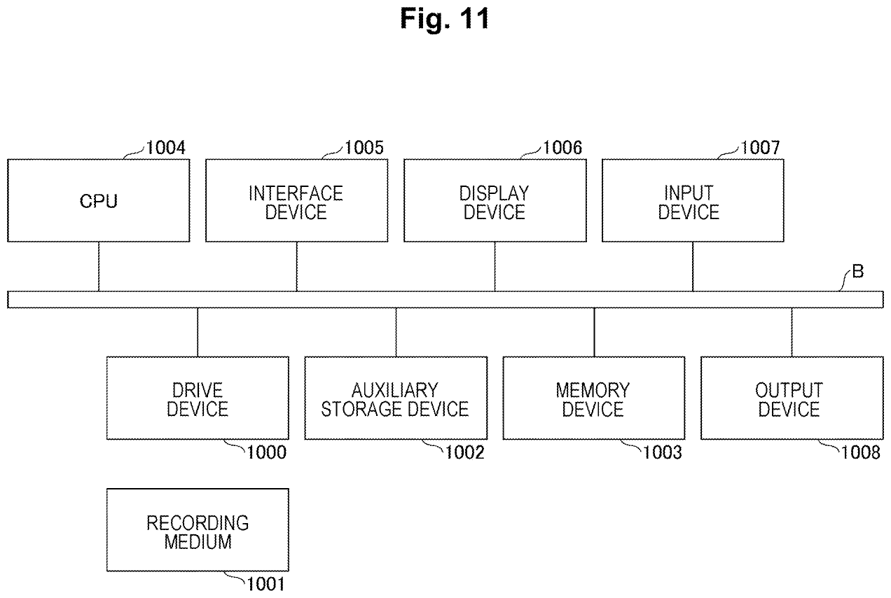

FIG. 11 is a diagram illustrating a hardware configuration example of each of the one or more computers. Each of the one or more computers in FIG. 11 includes a drive device 1000, an auxiliary storage device 1002, a memory device 1003, a CPU 1004, an interface device 1005, a display device 1006, an input device 1007, an output device 1008, and the like, which are connected to each other by a bus BS.

A program for implementing processing in the computer is provided through a recording medium 1001 such as a CD-ROM or a memory card, for example. When the recording medium 1001 storing the program is set in the drive device 1000, the program is installed on the auxiliary storage device 1002 from the recording medium 1001 via the drive device 1000. Here, the program is not necessarily installed from the recording medium 1001, and may be downloaded from another computer via a network. The auxiliary storage device 1002 stores the installed program, and also stores necessary files, data, and the like.

When an instruction to start the program is made, the memory device 1003 reads the program from the auxiliary storage device 1002 and stores the program. The CPU 1004 implements a function related to the queue computation system 100 in accordance with the program stored in the memory device 1003. The interface device 1005 is used as an interface for connection to a network or the like. The display device 1006 displays a graphical user interface (GUI) or the like by the program. The input device 1007 is constituted by a keyboard and a mouse, buttons, a touchscreen, or the like, and is used to input various operation instructions. The output device 1008 outputs a calculation result.

### Effects of Embodiment

The technology according to the present embodiment can achieve a priority queue that can be operated with data being encrypted, for example, between a client and a server or between a plurality of servers. At that time, it is possible to achieve a data structure or an operation algorithm thereof capable of achieving all of (1) high security in which stochastic corruption does not occur, (2) advanced operation such as data deletion and priority change, and (3) concealment of operation contents, which have not been achieved in conventional arts.

That is, with the novel data structure and its operation algorithm according to the present embodiment, it is possible to achieve an oblivious priority queue that achieves both high security and advanced functions, which have not been achieved conventionally.

### Supplementary Notes

The present specification discloses at least a queue computation system, a queue computation apparatus, a queue computation method, and a program in the following clauses.

### Clause 1

A queue computation system that executes processing on an oblivious priority queue, the queue computation system including:
a storage unit that stores a data structure in which layered randomized arrays and a binary tree are combined; and
a calculation unit that performs an operation on the data structure,
wherein, in the data structure, each piece of data is stored in a randomized array of any layer together with a priority, and each node in the binary tree is capable of retaining, as element information, data, priority, position, and layer information in the randomized arrays.

### Clause 2

The queue computation system according to clause 1, in which
in an update operation, the calculation unit takes, as input, an update target node in the binary tree, selects element information with lowest priority from among element information retained by a left child node of the update target node, element information retained by a right child node of the update target node, and element information of a randomized array corresponding to the update target node, and stores the selected element information in the update target node.

### Clause 3

The queue computation system according to clause 1, wherein
the calculation unit has a function of executing one or both of an insertion operation and a delete operation,
in the insertion operation, the calculation unit takes, as input, new data that is data to be newly inserted into the randomized arrays, specifies an empty layer in the layered randomized arrays, moves and stores, in the empty layer, all pieces of data in layers higher than the layer together with the new data, and updates, in order from the layer in which the new data is stored to an upper layer, all nodes belonging to each of the layers by the update operation, and
in the delete operation, the calculation unit takes, as input, a position and a layer of deletion target data that is data to be deleted from the randomized arrays, performs reference and data deletion on the position in a layer that retains the deletion target data, performs dummy reference and data deletion in each layer that does not retain the deletion target data, and updates nodes by the update operation from a lower layer to an upper layer for all positions subjected to reference.

### Clause 4

The queue computation system according to any one of clauses 1 to 3, in which
the calculation unit returns data retained by a node of an uppermost layer in the data structure in a highest-priority data reference operation.

### Clause 5

The queue computation system according to clause 4 depending from clause 3, wherein
the calculation unit has a function of executing at least one of a highest-priority data extraction operation, a priority change operation, or an operation content concealing operation,
in the highest-priority data extraction operation, the calculation unit acquires highest-priority data and position information of the highest-priority data by the highest-priority data reference operation according to clause 4, and deletes data at a position indicated by the position information by the delete operation according to clause 3,
in the priority change operation, the calculation unit deletes data at a change target position by the delete operation according to clause 3, and inserts a changed priority and the data by the insertion operation according to clause 3, and
in the operation content concealing operation, the calculation unit replaces input information corresponding to information expressing an operation content with a dummy, and executes the highest-priority data reference operation according to clause 4 and the delete operation and the insertion operation according to clause 3.

### Clause 6

A queue computation apparatus that executes processing on an oblivious priority queue, the queue computation apparatus including:
a storage unit that stores data having a data structure in which layered randomized arrays and a binary tree are combined; and
a calculation unit that performs an operation on the data,
wherein, in the data structure, each piece of data is stored in a randomized array of any layer together with a priority, and each node in the binary tree is capable of retaining data, priority, position, and layer information in the randomized arrays.

### Clause 7

A queue computation method in a queue computation system that executes processing on an oblivious priority queue, the queue computation system including a storage unit that stores a data structure in which layered randomized arrays and a binary tree are combined, the queue computation method including:
a calculation step of performing an operation on the data structure,
wherein, in the data structure, each piece of data is stored in a randomized array of any layer together with a priority, and each node in the binary tree is capable of retaining, as element information, data, priority, position, and layer information in the randomized arrays, and
the calculation step includes, as an update operation, taking, as input, an update target node in the binary tree, selecting element information with lowest priority from among element information retained by a left child node of the update target node, element information retained by a right child node of the update target node, and element information of a randomized array corresponding to the update target node, and storing the selected element information in the update target node.

### Clause 8

A program for causing a computer to function as each unit in the queue computation system according to any one of clauses 1 to 5.

While the present embodiment has been described above, the present invention is not limited to such a specific embodiment, and various modifications and changes can be made within the scope of the gist of the present invention described in the claims.

### REFERENCE LITERATURES

[1] Octavian Catrina and Sebastiaan de Hoogh. Improved primitives for secure multiparty integer computation. In Juan A. Garay and Roberto De Prisco, editors, Security and Cryptography for Networks, pp. 182-199, Berlin, Heidelberg, 2010. Springer Berlin Heidelberg.
[2]T.-H. Hubert Chan, Kartik Nayak, and Elaine Shi. Perfectly secure oblivious parallel ram. In Amos Beimel and Stefan Dziembowski, editors, Theory of Cryptography, pp. 636-668, Cham, 2018. Springer International Publishing.
[3] Zahra Jafargholi, Kasper Green Larsen, and Mark Simkin. Optimal oblivious priority queues. Cryptology ePrint Archive, Report 2019/237, 2019. https://eprint.iacr.org/2019/237.
[4] Marcel Keller and Peter Scholl. Efficient, oblivious data structures for MPC. In Advances in Cryptology—ASIACRYPT 2014, Part II, volume 8874 of Lecture Notes in Computer Science, pages 506-525, Kaoshiung, Taiwan, R.O.C., Dec. 7-11, 2014. Springer, Heidelberg, Germany.
[5] Peeter Laud. Parallel oblivious array access for secure multiparty computation and privacy-preserving minimum spanning trees. Proceedings on Privacy Enhancing Technologies, Vol. 2015, No. 2, pp. 188-205, 2015.
[6] Sarvar Patel, Giuseppe Persiano, and Kevin Yeo. CacheShuffle: A family of oblivious shuffles. In Ioannis Chatzigiannakis, Christos Kaklamanis, DAniel Marx, and Donald Sannella, editors, ICALP 2018: 45th International Colloquium on Automata, Languages and Programming, volume 107 of LIPIcs, pages 161:1-161:13, Prague, Czech Republic, Jul. 9-13, 2018. Schloss Dagstuhl—Leibniz-Zentrum fuer Informatik.
[7] Adi Shamir. How to share a secret. Commun. ACM, Vol. 22, No. 11, p. 612-613, November 1979.
[8] Elaine Shi. Path oblivious heap. IACR Cryptology ePrint Archive, 2019:274, 2019.
[9] Gurpreet Singh and Supriya. A study of encryption algorithms (RSA, DES, 3DES and AES) for information security. Int. J. Comput. Appl., vol. 67, no. 19, pp. 975-8887, 2013.
[10] Tomas Toft. Secure data structures based on multi-party computation. In PODC, pages 291-292, 2011.
[11] Xiao Shaun Wang, Kartik Nayak, Chang Liu, T-H. Hubert Chan, Elaine Shi, Emil Stefanov, and Yan Huang. Oblivious Data Structures. In CCS, 2014.
[12] Naoto Kiribuchi, Dai Ikarashi, Koki Hamada, and Ryo Kikuchi. A Library for Programmable Secure Computation MEVAL3. Proceedings of the 2018 Symposium on Cryptography and Information Security (SCIS) (2018).

### REFERENCE SIGNS LIST

10-1 to n Server
20 Client terminal
30 Network
100 Queue computation system
110 Input unit
120 Calculation unit
130 Output unit
140 Storage unit
1000 Drive device
1001 Recording medium
1002 Auxiliary storage device
1003 Memory device
1004 CPU
1005 Interface device
1006 Display device
1007 Input device
1008 Output device

1. A queue computation system that executes processing on an oblivious priority queue, the queue computation system comprising:
a processor; and
a memory storing program instructions that cause the processor to:
store, in the memory, a data structure in which layered randomized arrays and a binary tree are combined; and
perform an operation on the data structure,
wherein, in the data structure, each piece of data is stored in a randomized array of any layer together with a priority, and each node in the binary tree is capable of retaining, as element information, data, priority, position, and layer information in the layered randomized arrays.

2. The queue computation system according to claim 1, wherein, in an update operation, the program instructions cause the processor to take, as input, an update target node in the binary tree, select element information with lowest priority from among element information retained by a left child node of the update target node, element information retained by a right child node of the update target node, and element information of a randomized array corresponding to the update target node, and store the selected element information in the update target node.

3. The queue computation system according to claim 2, wherein the program instructions cause the processor to execute one or both of an insertion operation and a delete operation,
in the insertion operation, the program instructions cause the processor to take, as input, new data that is data to be newly inserted into the randomized arrays, specify an empty layer in the layered randomized arrays, move and store, in the empty layer, all pieces of data in layers higher than the layer together with the new data, and update, in order from the layer in which the new data is stored to an upper layer, all nodes belonging to each of the layers by the update operation, and
in the delete operation, the program instructions cause the processor to take, as input, a position and a layer of deletion target data that is data to be deleted from the randomized arrays, perform reference and data deletion on the position in a layer that retains the deletion target data, perform dummy reference and data deletion in each layer that does not retain the deletion target data, and update nodes by the update operation from a lower layer to an upper layer for all positions subjected to reference.

4. The queue computation system according to claim 3, wherein the program instructions cause the processor to return data retained by a node of an uppermost layer in the data structure in a highest-priority data reference operation.

5. The queue computation system according to claim 4, wherein the program instructions cause the processor to execute at least one of a highest-priority data extraction operation, a priority change operation, or an operation content concealing operation,
in the highest-priority data extraction operation, the program instructions cause the processor to acquire highest-priority data and position information of the highest-priority data by the highest-priority data reference operation, and delete data at a position indicated by the position information by the delete operation,
in the priority change operation, the program instructions cause the processor to delete data at a change target position by the delete operation, and insert a changed priority and the data by the insertion operation, and
in the operation content concealing operation, the program instructions cause the processor to replace input information corresponding to information expressing an operation content with a dummy, and execute the highest-priority data reference operation and the delete operation and the insertion operation.

6. A queue computation apparatus that executes processing on an oblivious priority queue, the queue computation device comprising:
a processor; and
a memory storing program instructions that cause the processor to:
store, in the memory, data having a data structure in which layered randomized arrays and a binary tree are combined; and
perform an operation on the data,
wherein, in the data structure, each piece of data is stored in a randomized array of any layer together with a priority, and each node in the binary tree is capable of retaining data, priority, position, and layer information in the randomized arrays.

7. A queue computation method performed by a queue computation system that executes processing on an oblivious priority queue, the queue computation system including a storage that stores a data structure in which layered randomized arrays and a binary tree are combined, the queue computation method comprising:
performing an operation on the data structure,
wherein, in the data structure, each piece of data is stored in a randomized array of any layer together with a priority, and each node in the binary tree is capable of retaining, as element information, data, priority, position, and layer information in the randomized arrays, and
the performing of the operation includes, as an update operation, taking, as input, an update target node in the binary tree, selecting element information with lowest priority from among element information retained by a left child node of the update target node, element information retained by a right child node of the update target node, and element information of a randomized array corresponding to the update target node, and storing the selected element information in the update target node.

8. (canceled)

9. A non-transitory computer-readable recording medium having computer-readable instructions stored thereon, which, when executed, cause a computer including a memory and processor to execute the queue computation method of claim 7.
